(19) United States
(12) Patent Application Publication
(10) Pub. No.: US 2009/0179134 A1
(43) Pub. Date: Jul. 16, 2009

(54) MODULAR DECK ASSEMBLY FOR A VIBRATORY APPARATUS

(75) Inventors: Dan Britton, Barrington, IL (US); Ronald Fruit, Woodstock, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: GENERAL KINEMATICS CORPORATION, Crystal Lake, IL (US)

(21) Appl. No.: 12/350,671

(22) Filed: Jan. 8, 2009

Related U.S. Application Data
(60) Provisional application No. 61/020,259, filed on Jan. 10, 2008.

(51) Int. Cl. F16M 13/00; F16M 11/20

(52) U.S. Cl. 248/559; 248/560

(57) ABSTRACT

According to an aspect of the disclosure, a vibratory apparatus includes a trough having a deck, the deck defined by a plurality of modular deck pieces connected to each other. The apparatus also includes a plurality of resilient members attached to the trough and supporting the trough, and a vibration generator coupled to the trough.

This application claims the benefit of U.S. Provisional Patent Application 61/020,259, filed Jan. 10, 2008, which application is incorporated herein by reference in its entirety.

### BACKGROUND

This patent is directed to a deck for a vibratory apparatus, and, in particular, to a modular deck assembly for a vibratory apparatus and its method of assembly and use.

### SUMMARY

According to an aspect of the disclosure, a vibratory apparatus includes a trough having a deck, the deck defined by a plurality of modular deck pieces connected to each other. The apparatus also includes a plurality of resilient members attached to the trough and supporting the trough, and a vibration generator coupled to the trough.

### BRIEF DESCRIPTION OF THE DRAWINGS

FIG. 1 is a schematic view of a vibratory apparatus according an embodiment of the present disclosure;

FIG. 2 is an isometric view of a modular deck piece to be used with the vibratory apparatus of FIG. 1 to define the deck thereof;

FIG. 3 is an end view of the modular deck piece of FIG. 2; and

FIG. 4 is a plan view of the modular deck piece of FIG. 2.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

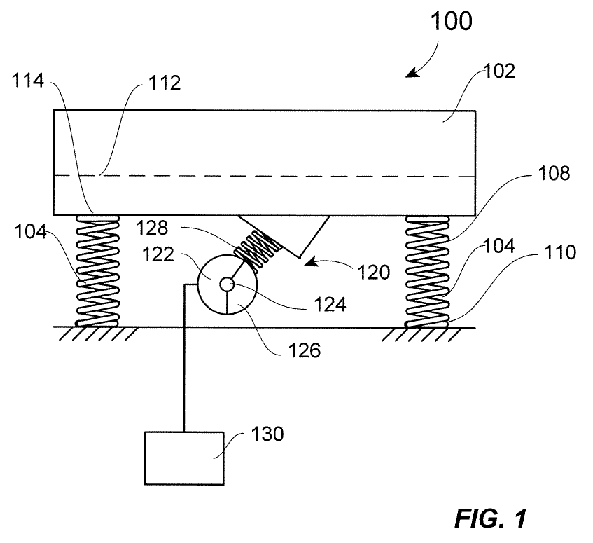

FIG. 1 illustrates an embodiment of a vibratory apparatus 100 that may have a deck according to the present disclosure. This embodiment is intended to be a non-limiting example of the possible apparatuses that may use modular deck pieces according to the present disclosure to define a modular deck assembly. For example, it will be recognized that considerable variation may occur in the apparatus 100 relative to the structures that support the trough and in the manner and shape of the vibration generator, as will be touched on briefly below.

The apparatus 100 may include a trough 102 that is supported above a surface by a plurality of resilient members 104. According to certain embodiments, the resilient members 104 may be paired with linkages. The resilient members 104 may be attached at one end 108 to the trough 102 and at a second end 110 to the surface, typically via a support structure that may be bolted or otherwise secured to the surface. The trough 102 may have a deck 112 disposed therein, the details of which are discussed below. The trough 102 may include a floor 114 beneath the deck 112, as illustrated, or there may be an opening in the trough 102 beneath the deck 112. Further, the deck 112 may include other structures other than the modular deck pieces described below.

One or more vibration generators 120 may be coupled to the trough 102. The vibration generator 120 may include a motor 122 having a shaft 124 to which one or more eccentric weights 126 are attached, for example. According to other embodiments, the vibration generator 120 may include pneumatic and/or hydraulic actuators instead of the motor 122. For that matter, the shaft 124 and weights 126 may be attached to the trough 120, while the motor 122 is coupled to the shaft 124, but not mounted on the apparatus 100.

The motor 122, shaft 124 and weights 126 (or shaft 124 and weights 126) may be coupled to the trough 102 via one or more resilient members 128, as illustrated. It will be recognized that the motor 122 may instead be coupled directly to the trough 102, or to a counterbalance that is then attached to the trough 102. It will also be recognized that one or more weights or stabilizers may be used in conjunction with the motor 122.

The vibration generator 120 may cause motion of the trough 102 and associated deck 112, as well as motion of objects supported on the deck 112. The generator 120 may cause the objects to move from one end of the trough 102 to the other, may cause the objects to move up and down without significant lateral motion relative to either end, or some combination thereof. The operation of the generator 120 may be controlled by a controller 130 that may be coupled to the generator 120, particularly to the motor 122. The controller 130 may be programmable, and may vary the operation of the generator 120.

The deck 112 according to the present disclosure is structured along the lines of those decks described in U.S. Pat. No. 7,186,347, which patent is incorporated herein in its entirety. It will be appreciated that while the deck pieces illustrated will define a deck 112 similar to an embodiment disclosed in U.S. Pat. No. 7,186,347 wherein a plurality of V-shaped angles are used to define the deck 112, other modular decks may be made in keeping with the other embodiments disclosed in U.S. Pat. No. 7,186,347, such at those defined by hemispherical or trapezoidal-shaped bars.

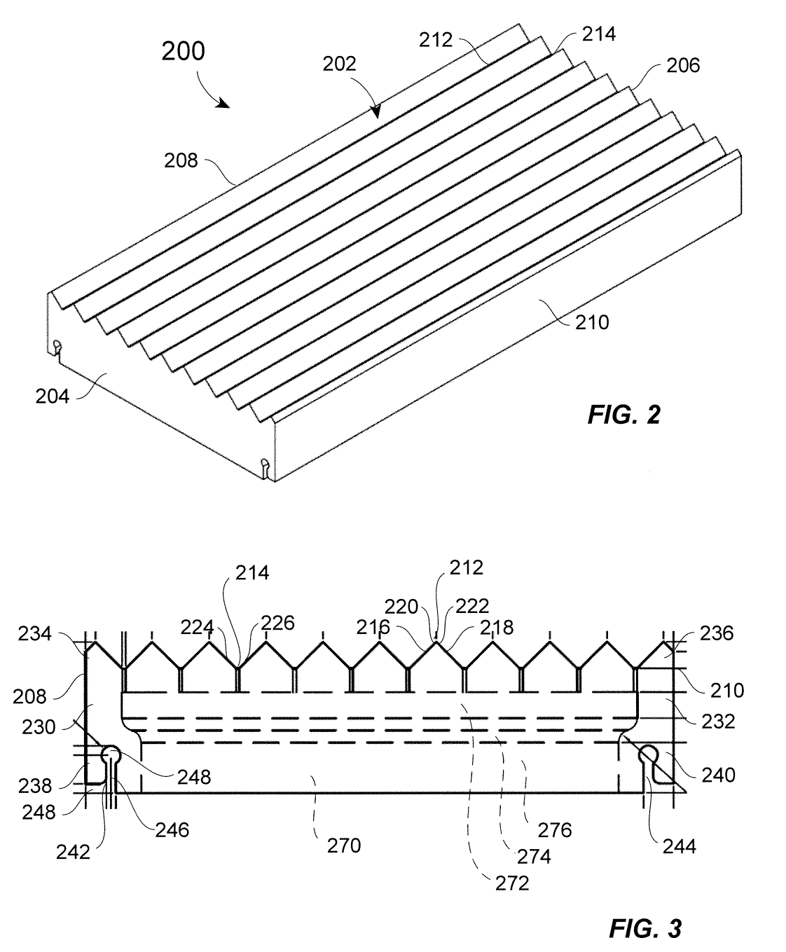

Referring now to FIG. 2, a modular deck piece 200 is illustrated. The modular deck piece 200 may be made from a polymer, for example. It will be recognized that the exact nature of the material used in fabricating the deck piece 200 will be influenced by the nature of the processing to be conducted using the apparatus 100.

The modular deck piece 200 defines, in part, the deck 112 illustrated in FIG. 1. That is, a plurality of deck pieces 200 will be used to define the deck 112. For example, three deck pieces 200 may be coupled together in the direction into the page of FIG. 1, while four or more deck pieces may be coupled together from left to right in the apparatus 100 illustrated in FIG. 1. It will be recognized that the number of pieces 200 joined together for a particular application of the present disclosure will be a factor of the size of the pieces 200 relative to the size of the deck 112 that the pieces 200 will define.

The deck piece 200 has an upper surface 202, ends 204, 206 and side edges 208, 210. As seen in FIGS. 2 and 3, the upper surface 202 has a repeating triangular pattern as viewed from either end 204, 206, with a plurality of apexes 212 and a plurality of passages 214. The apexes 212 are defined by a first solid wall surface 216 and a second solid wall surface 218, the first and second wall surfaces 216, 218 joined along a first edge 220, 222. The first and second wall surfaces 216, 218 also have second edges 224, 226 that are spaced from one another to define one of the passages 214. Solid material is supported on the surfaces 216, 218 so as to allow liquid to drain from the solid material and flow through the passage 214.

At either side edge 208, 210 of the deck piece 200 is a wall 230, 232. The walls 230, 232 have an upper section 234, 236 that may be formed in keeping with the upper surface 202 of the deck piece 200, such that the pieces 200, when placed together side-to-side, present a continuous pattern of apexes 212 and passages 214. Alternatively, the upper section 234, 236 may not be formed in keeping with the upper surface 202 of the piece 200, so as to present discontinues in the deck profile when viewed from one side wall to the other. These discontinuities may include the absence of apexes or passages, or a difference in the number or spacing of the apexes or passages in those regions of the deck 112.

As illustrated in FIGS. 2 and 3, the walls 230, 232 may have a lower section 238, 240 as well. The lower section 238, 240 may have a groove 242, 244 formed therein. As best seen in FIG. 3, the groove 242, 244 may have an L-shaped section 246 terminating in an open end 248 and in a closed end 250 of round cross-section. The grooves 242, 244 may be used to couple adjacent deck pieces 200 together. That is, a coupling or clip may be disposed into the grooves 242, 244, the coupling or clip having a profile that substantially mates with the grooves 242, 244 to limit the movement of the pieces 200 relative to each other. It will be recognized that such couplings or clips may extend the entire length of the pieces between the ends 204, 206, may extend beyond the ends 204, 206, or may extend for only a portion of the length of the piece 200 between the walls 204, 206.

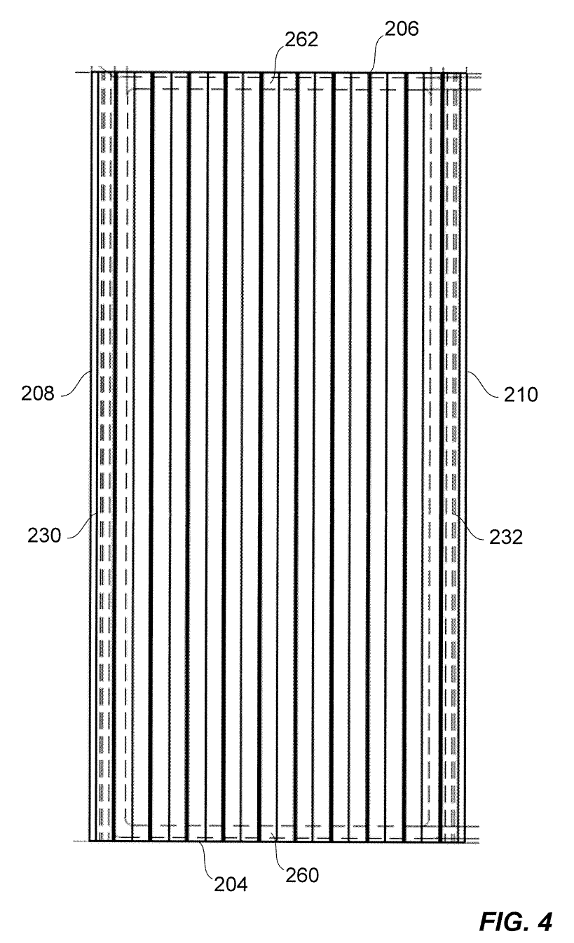

As best seen in FIG. 4, the deck piece 200 may also include walls 260, 262 at the ends 204, 206. As such, while the upper surface 202 extends from end to end 204, 206 and from side edge to side edge 208, 210, the remainder of the piece 200 below the upper surface 202 is relatively hollow, the walls 230, 232, 260, 262 defining a passage 270 through which liquid and/or particle fines may pass. In fact, each of the walls 230, 232, 260, 262 may have a stepped profile, such that the passage 270 has a first section 272 of greater cross-sectional area that tapers in a transitional section 274 to a second section 276 of smaller cross-sectional area.

It is believed that the present disclosure may have several benefits, one or more of which may be present in a particular embodiment according to the present disclosure.

For instance, a modular deck assembly may permit easier fabrication that with a deck that requires bars that will extend the length of the deck. Additionally, a modular deck assembly may permit easier installation and removal, which may facilitate repair of a damaged section of the deck in those instances where the remainder of the deck is undamaged.

What is claimed is:

1. A vibratory apparatus comprising:
a trough having a deck, the deck defined by a plurality of modular deck pieces connected to each other;
a plurality of resilient members attached to the trough and supporting the trough; and
a vibration generator coupled to the trough.

2. The vibratory apparatus according to claim 1, wherein each modular deck piece is a modular polymer deck piece.

3. The vibratory apparatus according to claim 1, wherein each modular deck piece has an upper surface with a plurality of apexes and a plurality of passages, the apexes and passages being defined by a first solid wall surface and a second solid wall surface, the first and second wall surfaces joined along a first edge to define one of the plurality of apexes and the first and second wall surfaces spaced along second edges from one another to define one of the plurality of passages.

4. The vibratory apparatus according to claim 3, wherein the trough has a floor disposed beneath the deck to receive any liquid passing through the plurality of passages in each modular deck piece.

5. The vibratory apparatus according to claim 1, wherein each modular deck piece has a side wall with a groove formed therein, the grooves of adjacent modular deck pieces being aligned to receive a connector therein to couple the deck pieces together.

6. The vibratory apparatus according to claim 5, wherein each groove has a L-shaped section.

7. The vibratory apparatus according to claim 1, each modular deck piece comprising an upper surface with a plurality of passages, first and second ends and first and second side edges, and walls disposed at the first and second ends and the first and second side edges to define a single passage below the upper surface of the modular deck piece in fluid communication with the plurality of passages.

8. The vibratory apparatus according to claim 7, wherein each of the walls has a stepped profile, such that the single passage has a first section with a first cross-sectional area and a second section with a second cross-sectional area that is smaller than the first cross-sectional area.

9. The vibratory apparatus according to claim 1, wherein the vibration generator comprises a motor having a shaft to which one or more eccentric weights are attached.

10. The vibratory apparatus according to claim 9, wherein the motor, the shaft and the weights are coupled to the trough via one or more resilient members.
